(19) United States
(12) Patent Application Publication
(10) Pub. No.: US 2025/0373945 A1
(43) Pub. Date: Dec. 4, 2025

(54) TRAFFIC INFORMATION GENERATION SYSTEM, TRAFFIC INFORMATION GENERATION DEVICE, AND TRAFFIC INFORMATION GENERATION METHOD

(71) Applicant: NEC Corporation, Minato-ku, Tokyo (JP)

(72) Inventors: Kazuki OGATA, Tokyo (JP); Yuji SATO, Tokyo (JP); Takashi TONEGAWA, Tokyo (JP); Jun TAKASAWA, Tokyo (JP); Hideki KIKKAWA, Tokyo (JP)

(73) Assignee: NEC Corporation, Minato-ku, Tokyo (JP)

(21) Appl. No.: 18/877,451

(22) PCT Filed: Aug. 8, 2022
(86) PCT No.: PCT/JP2022/030314

§ 371 Date: Dec. 20, 2024

(51) Int. Cl. H04N 23/68; G06V 20/54; G08G 1/01

(52) U.S. Cl. CPC H04N 23/683; G06V 20/54; G08G 1/0116; G08G 1/0129; G08G 1/0133; G08G 1/0141; G08G 1/0145; G06V 2201/08

(57) ABSTRACT

The information generation system includes a traffic information generation unit for generating, as an image, information about traffic on a road for a prescribed period, and a notification acquisition unit for acquiring a notification indicating the period of occurrence of a disaster in the vicinity of the road; the traffic information generation unit uses a first generation process to generate the traffic information for a period from which the time of occurrence has been excluded from the prescribed period, and uses a second generation process different from the first generation process to generate the traffic information for the period of occurrence during the prescribed period.

### TECHNICAL FIELD

The present invention relates, for example, to a traffic information generation system and the like concerning a technique for acquiring traffic information as an image.

### BACKGROUND ART

In recent years, further advancement for traffic control by means of a traffic signal and the like that provide an instruction to a vehicle on a road has been studied. The advancement is, for example, to provide an instruction to a vehicle and to support coordination among traffic signals by using traffic information acquired by an imaging means attached to equipment on a road, such as a traffic light. A technique for correcting image shaking in such an imaging means is disclosed in PTL 1.

### CITATION LIST

### Patent Literature

[PTL 1] International Patent Publication No. WO2018/159145

### SUMMARY OF INVENTION

### Technical Problem

In a case as described above where an imaging means is attached to equipment on a road, when a disaster such as an earthquake occurs, the imaging means vibrates, and therefore adequate traffic information may not be acquired from the imaging means.

In view of the problem described above, an object of the present invention is to acquire adequate traffic information even in a case where a disaster occurs.

### Solution to Problem

A traffic information generation system according to the present invention includes:
a traffic information generation means for generating, as an image, traffic information of a road in a prescribed period; and
a notification acquisition means for acquiring a notification indicating an occurrence period of a disaster in a vicinity of the road, wherein
the traffic information generation means
   generates, by first generation processing, the traffic information in a period excluding the occurrence period in the prescribed period, and
   generates, by second generation processing being different from the first generation processing, the traffic information in the occurrence period in the prescribed period.

A traffic information generation device according to the present invention includes:
a traffic information generation means for generating, as an image, traffic information of a road in a prescribed period; and
a notification acquisition means for acquiring a notification indicating an occurrence period of a disaster in a vicinity of the road, wherein
the traffic information generation means
   generates, by first generation processing, the traffic information in a period excluding the occurrence period in the prescribed period, and
   generates, by second generation processing being different from the first generation processing, the traffic information in the occurrence period in the prescribed period.

A traffic information generation method according to the present invention includes:
imaging a road in a prescribed period;
acquiring a notification indicating an occurrence period of a disaster in a vicinity of the road;
generating, by first generation processing, an image in a period excluding the occurrence period in the prescribed period, as first traffic information; and
generating, by second generation processing being different from the first generation processing, an image in the occurrence period in the prescribed period, as second traffic information.

### Advantageous Effects of Invention

According to the present invention, it is possible to acquire adequate traffic information, even in a case where a disaster occurs.

### BRIEF DESCRIPTION OF DRAWINGS

FIG. 1 is a block diagram illustrating a configuration example of a communication system according to a first example embodiment of the present invention.

FIG. 2 is a flowchart illustrating an operation example of the communication system according to the first example embodiment of the present invention.

FIG. 3 is a block diagram illustrating a configuration example of a communication system according to a second example embodiment of the present invention.

FIG. 4 is a flowchart illustrating an operation example of the communication system according to the second example embodiment of the present invention.

FIG. 5 is a diagram illustrating one example of an information processing device that achieves a traffic information generation system and the like according to the first and second example embodiments of the present invention.

### EXAMPLE EMBODIMENT

### First Example Embodiment

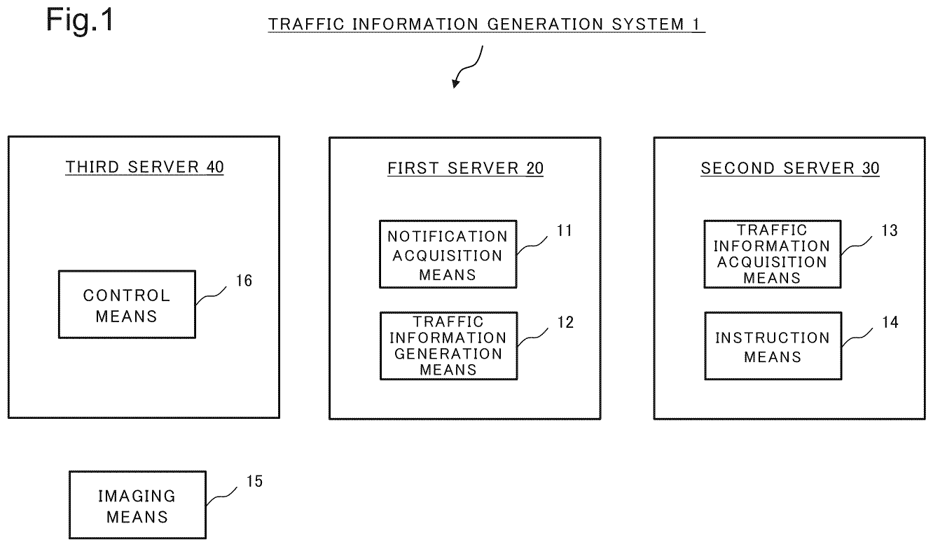

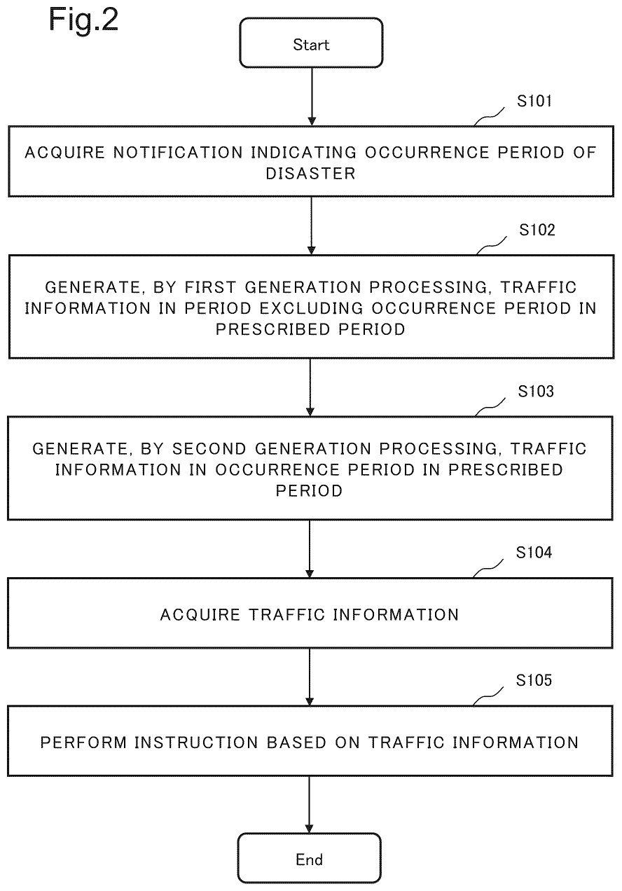

A traffic information generation system 1 according to a first example embodiment is described with reference to FIG. 1 and FIG. 2. FIG. 1 is a block diagram illustrating a configuration example of the traffic information generation system 1. FIG. 2 is a flowchart for describing an operation example of the traffic information generation system 1.

A configuration of the traffic information generation system 1 is described. The traffic information generation system 1 includes a first server 20, a second server 30, and a third server 40. The first server 20 includes a notification acquisition means 11 and a traffic information generation means 12. The second server 30 includes a traffic information acquisition means 13 and an instruction means 14. The third server 40 is connected to an imaging means 15. A control means 16 included in the third server 40 controls the imaging means 15 and acquires an image captured by the imaging means 15. Note that, the third server 40 is installed, for example, at a prescribed section of a road, an intersection, and the like, and is a most downstream server among the first to third servers 20, 30, and 40. Further, the second server 30 is installed at a facility such as a police station and a hospital, and is a middle stream server among the first to third servers 20, 30, and 40. Further, the first server 10 is installed at a municipal office and a ward office, and is a most upstream server among the first to third servers 20, 30, and 40.

In this way, each of the instruction means 14 and the traffic information generation means 12 is included in a server being different from one another. Note that, the notification acquisition means 11, the traffic information generation means 12, the traffic information acquisition means 13, the instruction means 14, and the imaging means 15 may be included in one traffic information generation device. Further, the first server 20, the second server 30, and the third server 40 include unillustrated communication means, and can communicate with each other.

The notification acquisition means 11 acquires a notification indicating an occurrence period of a disaster in a vicinity of a road. The notification acquisition means 11 surveys, for example, an external information medium such as a website of the Meteorological Agency. Further, the notification acquisition means 11 preliminarily stores location information corresponding to a location of the road. In a case where a period during which a disaster in a vicinity of the road occurred is published on the external information medium, the notification acquisition means 11 acquires a notification indicating the period. The road is a road surface and a roadside, and includes, for example, a roadway surface, a road surface within an intersection, a sidewalk, and the like. The disaster is damage to human social life and human life caused by an abnormal natural phenomenon or an artificial cause. As a specific example of the disaster, for example, article 2 of the Basic Act on Disaster Management provides that “the term disaster means damage resulting from a storm, tornado, heavy rainfall, heavy snowfall, flood, slope failure, mudflow, hightide, earthquake, tsunami, volcanic eruption, landslide, or other abnormal natural phenomena, or a large fire or explosion or other causes provided for by Cabinet Order and similar to the above in the extent of damage they cause”. Among these disasters, in particular, those that apply vibration to imaging means attached to equipment on a road, such as a traffic sign (for example, a storm (for example, including a storm accompanied by a typhoon and the like), a heavy rain, a heavy snow, an earthquake, a tsunami, a volcanic eruption, a landslide, and an explosion) are considered as a disaster in the present invention.

For example, the road is a portion of a road laid out in city A. In a case where a disaster occurs in the city A, the external information medium publishes that the disaster has occurred and an occurrence period of the disaster. The notification acquisition means 11 accesses to the external information medium and acquires a notification indicating the occurrence period of the disaster in the city A. Further, the notification acquisition means 11 may further acquire whether a disaster has occurred.

The traffic information generation means 12 generates traffic information of the road in a prescribed period, as an image. Specifically, the traffic information generation means 12 acquires an image capturing the road in the prescribed period and generates the traffic information from the image. Herein, a configuration for acquiring an image capturing the road in the prescribed period includes a configuration in which an image is acquired by the traffic information generation means capturing the road, and a configuration in which an image captured by the imaging means 15 is acquired. The configuration in which the traffic information generation means 12 captures the road includes a configuration in which the traffic information generation means 12 captures the road by controlling the imaging means 15 included in the third server 40.

The prescribed period is, for example, 10 minutes or one minute, but is not limited thereto. Herein, the traffic information in the present application is defined as information including image capturing a scene in which a person, a bicycle, an automobile, and the like pass by on the road. The traffic information in the present application may include, in addition to the image, location information corresponding to a location of the road. The imaging means 15 is installed in such a way as to be capable of imaging a road surface of a roadway, a sidewalk, and the like. Note that, the traffic information generation means 12 may include the function of the imaging means 15 and the traffic information generation means 12 may image the road, instead of the imaging means 15. Note that, the traffic information may be a moving image or a still image.

The traffic information generated by the traffic information generation means 12 is, for example, an image capturing a roadway. The traffic information generation means 12 generates an image, as the traffic information, by applying processing such as blur correction, color tone correction, and the like to the image captured by the imaging means 15. Note that, the traffic information generation means 12 may use the image captured by the imaging means 15 as the traffic information, without applying the processing. By checking the traffic information as an image, a user can identify a traffic condition of the road, such as the number of vehicles on the road, speed of a vehicle, and the like. Further, the traffic information may be output to the instruction means 14 described below and may be utilized for traffic control.

The traffic information generation means 12 generates, by first generation processing described below, the traffic information in a period excluding an occurrence period of a disaster from the prescribed period during which the road is imaged. Further, the traffic information generation means 12 generates, by second generation processing (described below) being different from the first generation processing, the traffic information in the occurrence period of the disaster in the prescribed period during which the road is imaged. Thus, the traffic information generation means 12 can generate each of the traffic information in the period in which no disaster occurs and the traffic information in a period in which a disaster occurs, using different generation processing for each other. Note that, the traffic information generated by the first generation processing corresponds to first traffic information. Further, the traffic information generated by the second generation processing corresponds to second traffic information.

Hereinafter, specific examples of the first generation processing and the second generation processing are described. In a first example, the first generation processing is processing of generating an image capturing the road acquired by the traffic information generation means as the traffic information, without applying correction based on a notification indicating an occurrence period of a disaster. Further, the second generation processing is processing of generating an image capturing the road acquired by the traffic information generation means as the traffic information, after applying the correction based on the notification indicating the occurrence period of the disaster.

The correction based on the notification indicating the occurrence period of the disaster is, for example, a correction of shaking or noise in a moving image. For example, in a case in which an earthquake happens, a vehicle and a person on the road are imaged shaking due to the earthquake. Therefore, the traffic information generation means 12 detects, from a notification indicating an occurrence period of a disaster (herein, a notification indicating an occurrence period of the earthquake), that the earthquake has happened, and corrects the image according to shaking due to the earthquake. Note that, the notification indicating the occurrence period of the disaster may include seismic intensity of the earthquake. In this case, the traffic information generation means 12 may correct the image, according to the seismic intensity. Meanwhile, in a period excluding the occurrence period of the earthquake, the traffic information generation means 12 generates the traffic information as an image, without performing correction based on the notification indicating the occurrence period of the disaster (herein, the notification indicating the occurrence period of the earthquake). Herein, the configuration of generating the traffic information without performing correction based on the notification indicating the occurrence period of the disaster may be either one of a configuration of generating, as the traffic information, the acquired image as it is, and a configuration of generating, as the traffic information, the acquired image after performing correction that is not based on the notification indicating the occurrence period of the disaster.

Next, a second example and a third example are described. In the second example, it is assumed that the traffic information generation means 12 includes the function of the imaging means 15, and an image of the road in the prescribed period is acquired by the traffic information generation means 12 imaging the road, but the second example is not limited to this example. In this case, the traffic information generation means 12 may image the road and may generate the traffic information, by using different servers. Specifically, the traffic information generation means 12 images the road by using the third server 40 and generates the traffic information by using the first server 20.

In the second example, the first generation processing is processing of generating, as the traffic information, an image of the road captured by the traffic information generation means 12 at a first frame rate. The first frame rate is, for example, 30 fps. Further, the second generation processing is processing of generating, as the traffic information, an image of the road captured by the traffic information generation means 12 at a second frame rate being higher than the first frame rate. The second frame rate is, for example, 50 fps or 60 fps.

An image captured in the occurrence period of the disaster is adversely affected by shaking due to the earthquake. Therefore, a user may hardly recognize a traffic condition such as the number of vehicles and speed of a vehicle, from the image captured in the occurrence period of the disaster. In the traffic information generation means 12, the image generated in the occurrence period of the disaster is captured at the second frame rate being higher than the first frame rate, therefore more information by the user can be provided.

Thus, according to the traffic information generation means 12, the user can more accurately identify a traffic condition such as the number of vehicles and speed of a vehicle, even from the traffic information generated in the occurrence period of the disaster. Further, in a case where the instruction means 14 described below performs traffic control based on the traffic information, the instruction means 14 can perform more appropriate traffic control, even in the occurrence period the disaster.

Note that, the first generation processing and the second generation processing may differ in shutter speed at a time of imaging, instead of the frame rate. Specifically, in the second generation processing, the road is imaged at a second shutter speed being faster than a first shutter speed used in the first generation processing. Since the image generated in the occurrence period of the disaster is captured at the second shutter speed being faster than the first shutter speed, an advantageous effect of reducing blurring due to the earthquake shaking in the image provided to the user can be expected.

Note that, the first generation processing and the second generation processing may differ in gain at a time of imaging, in addition to the frame rate or the shutter speed. Specifically, in the second generation processing, the road is imaged with a second gain being higher than a first gain used in the first generation processing. Specifically, the gain is an amplification factor for an electrical signal returned from light received by an image sensor element used for imaging.

Thus, according to the traffic information generation means 12, the user can more accurately identify a traffic condition such as the number of vehicles and speed of a vehicle, even from the traffic information generated in the occurrence period of the disaster. Further, in a case where the instruction means 14 described below performs traffic control based on the traffic information, the instruction means 14 can perform more appropriate traffic control, even in the occurrence period of the disaster.

The traffic information acquisition means 13 acquires the traffic information generated by the traffic information generation means 12. The traffic information acquisition means 13 is a communication means being capable of communicating with the first server 20 and the third server 40. By communicating with the first server 20, the traffic information acquisition means 13 acquires the traffic information generated by the traffic information generation means 12.

The instruction means 14 gives an instruction to at least one of a vehicle and a person, based on the traffic information acquired by the traffic information acquisition means 13. The instruction is traffic control by controlling a traffic signal, and the like. For example, instruction means 14 determines, based on the traffic information generated by the traffic information generation means 12, whether the number of vehicles traveling in a specific direction exceeds a threshold. In a case where the number of vehicles exceeds the threshold, the instruction means 14 controls a traffic signal giving instruction to the vehicle traveling in the direction, in such a way to increase a time for giving a passing instruction. Thereby, the traffic signal increases the time for giving green signal. Meanwhile, in a case where the number of vehicles exceeds the threshold, the instruction means 14 does not control the traffic signal in such a way to change a time for giving any instruction.

In the period excluding the occurrence period of the disaster from the prescribed period during which the road is imaged, the instruction means 14 performs the instruction, based on the traffic information generated by the first generation processing. Further, in the period of occurrence of the disaster in the prescribed period, the instruction means performs the instruction, based on the traffic information generated by the second generation processing. Therefore, the instruction means 14 can perform appropriate instruction, for example, by using an image having a higher frame rate.

Next, an operation example of the traffic information generation system 1 is described with reference to FIG. 2. The notification acquisition means 11 acquires a notification indicating an occurrence period of a disaster (S101) . . . . The traffic information generation means 12 generates the traffic information in a period excluding the occurrence period from the prescribed period, by the first generation processing (S102). The traffic information generation means 12 generates the traffic information in the occurrence period of the disaster in the prescribed period, by the second generation processing (S103). Note that, the first generation processing in S102 and the second generation processing in S103 may be executed according to either one of the first example, second example, and the third example.

The traffic information acquisition means 13 acquires the traffic information (S104). The instruction means 14 performs instruction based on the traffic information (S105). Specifically, in the period excluding the occurrence period of the disaster from the prescribed period, the instruction means 14 performs instruction, based on the traffic information generated by the first generation processing. Further, in the occurrence period in the prescribed period, the instruction means 14 performs the instruction, based on the traffic information generated by the second generation processing. Note that, processing in S102 and S103 need not be executed consecutively and may be configured in such a way that processing excluding S102 may be executed when a disaster occurs and processing excluding S103 may be executed when no disaster occurs.

As described above, the traffic information generation system 1 includes the traffic information generation means 12 and the notification acquisition means 11. The traffic information generation means 12 generates traffic information of a road in a prescribed period, as an image. Further, the notification acquisition means 11 acquires a notification indicating an occurrence period of a disaster in a vicinity of the road. The traffic information generation means 12 generates, by the first generation processing, the traffic information in a period excluding the occurrence period from the prescribed period. Further, the traffic information generation means 12 generates, by the second generation processing being different from the first generation processing, the traffic information in the occurrence period in the prescribed period.

In the traffic information generation system 1, the second generation processing of generating the traffic information in the occurrence period of the disaster differs from the first generation processing of generating the traffic information in the period excluding the occurrence period of the disaster. Therefore, in the second generation processing, the traffic information generation means 12 can execute preferable processing in response to an occurrence of the disaster.

Thus, by the second generation processing, the traffic information generation system 1 can generate the traffic information that is applied with processing appropriate to the disaster. The processing appropriate to the disaster is, for example, at least one of performing correction to the image, imaging at a higher fame rate, and imaging with a higher gain.

### Second Example Embodiment

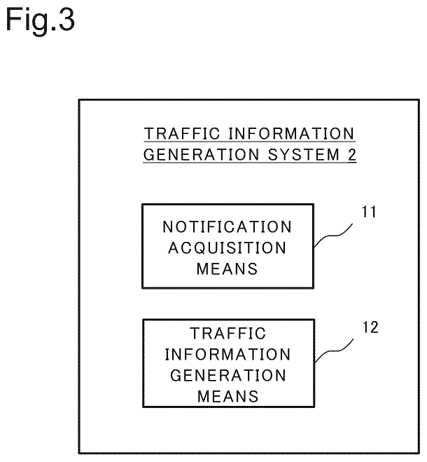

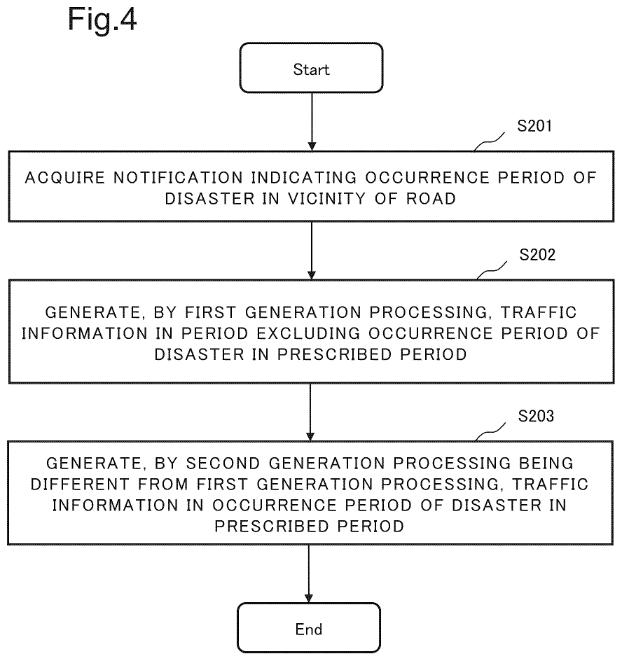

A traffic information generation system 2 according to a second example embodiment is described based on FIG. 3 and FIG. 4. FIG. 3 is a block diagram illustrating a configuration example of the traffic information generation system 2. FIG. 4 is a flowchart for describing an operation example of the traffic information generation system 2.

A configuration of the traffic information generation system 2 is described. As illustrated in FIG. 3, the traffic information generation system 2 includes a notification acquisition means 11 and a traffic information generation means 12. Note that, although the notification acquisition means 11 and the traffic information generation means 12 are provided integrally in FIG. 3, they may be provided separately.

The notification acquisition means 11 acquires a notification indicating an occurrence period of a disaster in a vicinity of a road. The notification acquisition means 11 according to the present example embodiment may include the same function and connection relationship as the notification acquisition means 11 according to the first example embodiment.

The traffic information generation means 12 generates traffic information of a road in a prescribed period, as an image. Specifically, the traffic information generation means 12 generates, by first generation processing, the traffic information of the road in a period excluding an occurrence period of a disaster from the prescribed period. Further, the traffic information generation means 12 generates, by second generation processing being different from the first generation processing, the traffic information of the road in the occurrence period of the disaster in the prescribed period. The traffic information generation means 12 according to the present example embodiment may include a function and a connection relationship similar to those of the traffic information generation means 12 according to the first example embodiment.

Next with reference to FIG. 4, a traffic information generation method by the traffic information generation system 2 is described. The notification acquisition means 11 acquires a notification indicating an occurrence period of a disaster in a vicinity of a road (S201). The traffic information generation means 12 generates, by the first generation processing, the traffic information in a period excluding the occurrence period of the disaster from a prescribed period (S202). The traffic information generation means 12 generates, by the second generation processing being different from the first generation processing, the traffic information in the occurrence period of the disaster in the prescribed period (S203).

As described above, in the traffic information generation system 2, the second generation processing of generating the traffic information in the occurrence period of the disaster is different from the first generation processing of generating the traffic information in the period excluding the occurrence period of the disaster. Therefore, in the second generation processing, the traffic information generation means 12 can execute preferable processing in response to an occurrence of the disaster. Thus, by the second generation processing, the traffic information generation system 2 can generate the traffic information that is applied with processing appropriate to the disaster. The processing appropriate to the disaster is, for example, at least one of correcting the image, imaging at a higher frame rate, and imaging with a higher gain.

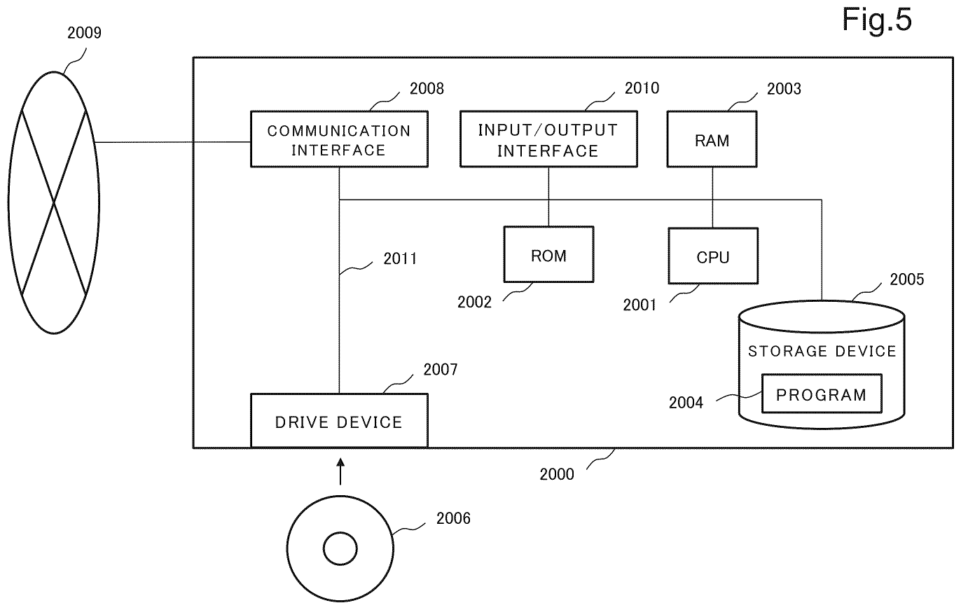

A part or the entirety of each component of each device or system is achieved, for example, by any combination of an information processing device 2000 and a program, such as illustrated in FIG. 5. FIG. is a diagram illustrating one example of an information processing device that achieves the traffic information generation systems 1, 2, and the like. As one example, the information processing device 2000 includes a configuration as follows.
Central processing unit (CPU) 2001
Read only memory (ROM) 2002
Random access memory (RAM) 2003
Program 2004 loaded onto RAM 2003
Storage device 2005 storing program 2004
Drive device 2007 for reading and writing on recording medium 2006
Communication interface 2008 connecting to communication network 2009
Input/output interface 2010 for inputting and outputting data
Bus 2011 connecting each component

Each component of each device according to each example embodiment is achieved by the CPU 2001 acquiring and executing the program 2004 that achieves a function of the component. The program that achieves a function of each component of each device is, for example, preliminarily stored in storage device 2005 and the RAM 2003, and read by the CPU 2001 as necessary. Note that, the program 2004 may be provided to the CPU 2001 via the communication network 2009, or may be stored in the recording medium 2006 in advance and be provided to the CPU 2001 by the drive device 2007 reading the program.

There are various modification examples of a method for achieving each device. For example, each device may be achieved by any combination of the information processing device 2000 and a program, separate for each component. Further, a plurality of components included in each device may be achieved by any single combination of the information processing device 2000 and a program.

Further, a part or the entirety of each component of each device is achieved by general or dedicated circuitry including a processor and the like, and a combination of the circuitry. The circuitry may be configured of a single chip or may be configured of a plurality of chips connected via a bus. A part or the entirety of each component of each device may be achieved by a combination of the circuitry and the like and a program.

In a case where a part or the entirety of each component of each device is achieved by a plurality of information processing devices, pieces of circuitry, and the like, the plurality of information processing devices, pieces of circuitry, and the like may be centralized or distributed. For example, the information processing devices, pieces of circuitry, and the like may be achieved in a form, such as a client-and-server system, a cloud computing system, and the like, in which each of the information processing devices, pieces of circuitry, and the like is connected via a communication network.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 2 Traffic information generation system
11 Notification acquisition means
12 Traffic information generation means
13 Traffic information acquisition means
14 Instruction means
15 Imaging means
16 Control means
20 First server
30 Second server
40 Third server
2001 CPU
2002 ROM
2003 RAM
2004 Program
2005 Storage device
2007 Drive device
2008 Communication interface
2009 Communication network
2010 Input/output interface
2011 Bus connecting each component

What is claimed is:

1. A traffic information generation system comprising:
a traffic information generation circuit configured to generate traffic information of a road in a prescribed period, as an image; and
a notification acquisition circuit configured to acquire a notification indicating an occurrence period of a disaster in a vicinity of the road, wherein
the traffic information generation circuit
generates, by first generation processing, the traffic information in a period excluding the occurrence period in the prescribed period, and
generates, by second generation processing being different from the first generation processing, the traffic information in the occurrence period in the prescribed period.

2. The traffic information generation system according to claim 1, wherein
the first generation processing is processing in which the traffic information generation circuit generates, as the traffic information, an acquired image capturing the road, without applying a correction based on a notification indicating the occurrence period, and
the second generation processing is processing in which the traffic information generation circuit generates, as the traffic information, an acquired image capturing the road, after applying a correction based on a notification indicating the occurrence period.

3. The traffic information generation system according to claim 1, wherein
the first generation processing is processing of generating, as the traffic information, an image capturing the road imaged by the traffic information generation circuit at a first frame rate, and
the second generation processing is processing of generating, as the traffic information, an image capturing the road imaged by the traffic information generation circuit at a second frame rate being higher than the first frame rate.

4. The traffic information generation system according to claim 3, wherein
the first generation processing is processing of generating, as the traffic information, an image capturing the road imaged by the traffic information generation circuit with a first gain, and
the second generation processing is processing of generating, as the traffic information, an image capturing the road imaged by the traffic information generation circuit with a second gain being higher than the first gain.

5. The traffic information generation system according to claim 1, further comprising:
a traffic information acquisition circuit configured to acquire the traffic information; and
an instruction circuit configured to perform instruction to at least one of a vehicle and a person on the road, based on the traffic information, wherein
the instruction circuit
performs the instruction, in the period excluding the occurrence period in the prescribed period, based on the traffic information generated by the first generation processing, and
performs the instruction, in the occurrence period in the prescribed period, based on the traffic information generated by second generation processing.

6. The traffic information generation system according to claim 5, wherein each of the instruction circuit and the traffic information generation circuit is achieved by a server being different from each other.

7. The traffic information generation system according to claim 1, wherein the traffic information generation circuit uses different servers for imaging the road and for generating the traffic information.

8. A traffic information generation device comprising:
a traffic information generation circuit configured to generate, as an image, traffic information of a road in a prescribed period; and
a notification acquisition circuit configured to acquire a notification indicating an occurrence period of a disaster in a vicinity of the road; wherein
the traffic information generation circuit
generates, by first generation processing, the traffic information in a period excluding the occurrence period in the prescribed period, and
generates, by second generation processing being different from the first generation processing, the traffic information in the occurrence period in the prescribed period.

9. The traffic information generation device according to claim 8, wherein
the first generation processing is processing in which the traffic information generation circuit generates, as the traffic information, an acquired image capturing the road, without applying a correction based on a notification indicating the occurrence period, and
the second generation processing is processing in which the traffic information generation circuit generates, as the traffic information, an acquired image capturing the road, after applying a correction based on a notification indicating the occurrence period.

10. The traffic information generation device according to claim 8- or 9, wherein
the first generation processing is processing of generating, as the traffic information, an image capturing the road imaged by the traffic information generation circuit at a first frame rate, and
the second generation processing is processing of generating, as the traffic information, an image capturing the road imaged by the traffic information generation circuit at a second frame rate being higher than the first frame rate.

11. The traffic information generation device according to claim 10, wherein
the first generation processing is processing of generating, as the traffic information, an image capturing the road imaged by the traffic information generation circuit at a first gain, and
the second generation processing is processing of generating, as the traffic information, an image capturing the road imaged by the traffic information generation circuit at a second gain being higher than the first gain.

12. The traffic information generation device according to claim 8, further comprising:
a traffic information acquisition circuit configured to acquire the traffic information; and
an instruction circuit configured to perform instruction to at least one of a vehicle and a person on the road, based on the traffic information, wherein
the instruction circuit
performs the instruction, in the period excluding the occurrence period in the prescribed period, based on the traffic information generated by the first generation processing, and
performs the instruction, in the occurrence period in the prescribed period, based on the traffic information generated by second generation processing.

13. A traffic information generation method comprising:
imaging a road in a prescribed period;
acquiring a notification indicating an occurrence period of a disaster in a vicinity of the road;
generating, by first generation processing, an image in a period excluding the occurrence period in the prescribed period, as first traffic information; and
generating, by second generation processing being different from the first generation processing, an image in the occurrence period in the prescribed period, as second traffic information.

14. The traffic information generation method according to claim 13, wherein
the first generation processing is processing of generating the first traffic information without applying a correction based on a notification indicating the occurrence period to an image capturing the road, and
the second generation processing is processing of generating the second traffic information after applying a correction based on a notification indicating the occurrence period to an image capturing the road.

15. The traffic information generation method according to claim 13, wherein
the first generation processing is processing of generating an image capturing the road imaged at a first frame rate, as the first traffic information, and
the second generation processing is processing of generating an image capturing the road imaged at a second frame rate being higher than the first frame rate, as the second traffic information.

16. The traffic information generation method according to claim 15, wherein
the first generation processing is processing of generating an image capturing the road imaged at a first gain, as the first traffic information, and
the second generation processing is processing of generating an image capturing the road imaged at a second gain being higher than the first gain, as the second traffic information.

17. The traffic information generation method according to claim 13, further comprising:
acquiring the traffic information;
performing instruction to at least one of a vehicle and a person on the road, in the period excluding the occurrence period in the prescribed period, based on the first traffic information generated by the first generation processing; and
performing instruction to at least one of a vehicle and a person on the road, in the occurrence period in the prescribed period, based on the second traffic information generated by the second generation processing.
